(19) United States
(12) Patent Application Publication
(10) Pub. No.: US 2018/0327186 A1
(43) Pub. Date: Nov. 15, 2018

(54) CONVEYING SYSTEM

(71) Applicant: WRH WALTER REIST HOLDING AG, CH-8272 ERMATINGEN (CH)

(72) Inventor: Carl Conrad MAEDER, Hittnau (CH)

(73) Assignee: WRH WALTER REIST HOLDING AG, CH-8272 ERMATINGEN (CH)

(21) Appl. No.: 15/775,930

(22) PCT Filed: Nov. 17, 2016
(86) PCT No.: PCT/EP2016/078039

§ 371 Date: May 14, 2018

(30) Foreign Application Priority Data
Nov. 17, 2015 (CH) 1674/15

(51) Int. Cl. B65G 17/06; B65G 47/96

(52) U.S. Cl. CPC B65G 17/065; B65G 47/962

(57) ABSTRACT

The invention relates to a conveying system (1) for conveying items (2.1, 2.2) to be conveyed. The conveying system (1) comprises a conveying path (30) and at least one first conveying means (6) that can move along the conveying path (30) and is designed to convey a first item (2.1) to be conveyed. The conveying system (1) also comprises at least one second conveying means (7) which can move along the conveying path (30) along with the first conveying means (6) and which is designed to convey a second item (2.2) to be conveyed that is of a different type than the first item (2.1).

### BACKGROUND OF THE INVENTION

### Field of the Invention

The invention lies in the field of conveying technology and relates to a conveying system for conveying items to be conveyed. Furthermore, the invention relates to a method for conveying and delivering items to be conveyed with such a conveying system.

Different conveying systems are known for conveying freely supported items to be conveyed.

### Discussion of Related Art

WO 2016/119071 A1 was filed on 22 Jan. 2016 in the name of WRH Walter Reist Holding AG and shows a conveying unit for a conveying installation in the manner of a tilt-tray conveyor. The shown conveying unit comprises a base body and a support element, which forms a support surface. By means of an inclining mechanism, the support surface can be inclined with respect to the base body, as a result of which an item to be conveyed arranged on the support surface can be delivered to a delivery side. The support surface is enclosed at least partially by a surrounding frame, which is intended to secure the items to be conveyed against slipping off from the support surface in certain situations. The application discloses that the conveying unit can be arranged on a conveying carriage, which can be moved along a longitudinal guide device.

DE 10 2006 077 838 A1 was filed on 17 Feb. 2006 and shows a tilt-tray conveyor. The latter comprises carriages which can be moved along an endless path, which carriages are provided with tiltable trays for receiving and delivering goods. The shapes of two trays arranged directly one after the other should be constituted corresponding to one another according to said application, such that the trays can be rotated in the conveying plane essentially gap-free beside one another. For this purpose, trays are shown which are constituted sickle-shaped. The application discloses that the trays should be tiltable transversely to the travel direction for the purpose of unloading goods placed on the trays. The formation of spaces between the trays during curved stretches is thus intended to be prevented, and a targeted loading and unloading of the trays along the entire conveying path is thus enabled.

DE 10 2009 034 935 A1 was filed on 28 Jul. 2009 and shows an installation for transporting and sorting packages and suchlike goods. The installation shown comprises exclusively conventional identical transport means. The nature and size of the uniform transport means used conforms to the largest transport item to be transported, as is otherwise customary in the prior art. In order to be able to convey smaller and/or flat-format items in a better manner, these items are transported according to the publication not lying on the individual transport means, but rather in retaining means constituted as cassettes which lie on these transport means.

WO 2012/068699 A1 was filed on 25 Nov. 2011 in the name of FERAG AG and shows a plate element of a conveyor for the formation of an assembled conveying surface, as well as a conveyor with a conveying element and a plurality of plate elements. The shown plate elements comprise an overlapping region in each case at two end portions lying opposite one another. The plate elements also form a plate conveying surface, wherein the two overlapping regions each form at least a part of the plate conveying surface. The two overlapping regions are each constituted complementary to one another, so that two plate elements jointed to one another can form a common assembled conveying surface. Such conveyors are well suited for the transport of piece goods, since even relatively heavy and spaciously bulky transport items can be distributed on fairly large conveying areas with them. However, there is the risk with such conveyors that specific types of items to be conveyed, especially in the case of inclines or gradients in the conveying path, or in the case of high conveying speeds in curved sections, start to slip or roll and can thus become damaged or fall from the conveyor.

A similarly constituted conveying installation is disclosed in WO 2012/068691 A1.

### SUMMARY OF THE INVENTION

The known conveying systems are each suitable for conveying a specific group of items to be conveyed, whereas other types of items to be conveyed cannot be conveyed with them or can be so only to a very limited extent (for example, with a reduced conveying speed).

As a consequence of this, a plurality of different conveying systems have often had to be operated hitherto in parallel with one another for many applications—such as for example in the context of production, sorting, order-picking or dispatch installations. On the one hand, this leads to a greater space requirement for the conveying installations, but on the other hand also to relatively high acquisition, operational and maintenance costs. In addition, if the items conveyed using the different systems have to be brought together—for example in the context of order-picking, an additional installation is required for this purpose or the items have to be brought together manually, which is often also bound up with additional costs.

The problem underlying the present invention, amongst other things, is therefore to solve one or more of the aforementioned problems. In particular, a conveying system and a method should be made available, with which a multiplicity of even very different items can be conveyed and/or sorted.

A conveying system according to the invention for conveying items to be conveyed usually comprises a conveying path and at least one first conveying means which can move along the conveying path and is configured for conveying a first item to be conveyed.

It normally also comprises at least one second conveying means which can move along the conveying path together with the first conveying means and is configured for conveying a second item to be conveyed that is different in nature from the first item to be conveyed.

A first and a second item to be conveyed may in particular be different in that they differ for example in their size (i.e. their spatial dimensions) and/or their weight and/or their external shape and/or their chemical composition and/or the static friction coefficient of their surfaces.

A conveying system particularly suitable for conveying a plurality of items to be conveyed can be achieved with an embodiment of the invention, wherein the at least one first conveying means comprises a conveying support composed of a number of successive support elements for conveying a first item to be conveyed lying freely on the assembled conveying support or wherein the at least one first conveying means comprises at least one tray for conveying a first item to be conveyed lying on the tray.

According to an embodiment of a conveying system according to the invention, the second conveying means comprises at least one conveying support composed of a number of successive support elements for conveying a second item to be conveyed lying freely on the assembled conveying support or the second conveying means comprises at least one tray for conveying a second item to be conveyed lying on the tray.

According to an embodiment of the conveying system according to the invention for conveying items to be conveyed, the latter comprises a conveying path and at least one conveying support which can move along the conveying path and is composed of a number of successive support elements as a first conveying means for conveying a first item to be conveyed lying freely on the conveying support. The latter also comprises at least one tray which can move along the conveying path together with the conveying support as a second conveying means for conveying a second item to be conveyed lying on the tray.

With such an embodiment of a conveying system according to the invention, even relatively large and/or heavy piece goods, in particular, can on the one hand be conveyed on the assembled conveying support. On the other hand, however, bulk goods for example, such as for example small or mass-produced parts, loose or for example packaged in small bags, can also be reliably conveyed on the tray. For a large number of applications, it is thus possible to convey or process a wide variety of different goods with the same conveying system.

According to an embodiment of a conveying system, the latter comprises as a first conveying means at least one tray for conveying a first item to be conveyed lying on the tray. It also comprises as a second conveying means at least one tray for conveying a second item to be conveyed lying on the tray.

In an embodiment of the conveying system according to the invention, the first conveying means comprises at least one tray of a first kind, which is configured for conveying a first item to be conveyed, and the second conveying means comprises at least one tray of a second kind, which is configured for conveying a second item to be conveyed, wherein the trays of the second kind have a larger spatial extension viewed in the conveying direction than the trays of the first kind. It is thus possible with the conveying system also to convey a second item to be conveyed that is larger than the first item to be conveyed and at the same time to optimise the conveying capacity of the conveying system.

In addition, an embodiment of a conveying system can also comprise a further (third) conveying means which can move along the conveying path together with a first conveying means comprising a first at least one tray of a first kind and a second conveying means comprising a second at least one tray of a second kind, which further conveying means comprises for example a conveying support composed of a number of successive support elements for conveying a further item to be conveyed lying on the conveying support, as will be explained in greater detail below.

Through the possible use of trays according to the invention, conveying systems are also possible with routing with relatively sharply ascending or descending conveying sections, since items to be conveyed can be securely conveyed by the trays on such sections.

According to an embodiment of the invention, the conveying system comprises a plurality of conveying supports composed of successive support elements and/or a plurality of trays.

The assembled conveying supports and/or trays can in each case be constituted identically or differently. Thus, for example, it is possible for a conveying system to comprise a plurality of trays of differing sizes.

In particular, a conveying system can comprise different kinds of trays each with different dimensions in the conveying direction, as will be discussed in greater detail below.

According to an embodiment of the conveying system according to the invention, the piece number of the items to be conveyed per unit of time can be increased for certain kinds of items to be conveyed, in particular for those of smaller dimensions, by the use of at least one or more trays of a first kind with a small dimension in the conveying direction and trays of a second kind with a larger dimension in the conveying direction compared to the trays of the first kind.

In an embodiment of the conveying system according to the invention, the conveying path is constituted as an endless loop. Items can thus be conveyed with a continuously high conveying capacity even over longer periods.

In an embodiment, the at least one first conveying means and the at least one second conveying means are driven by a conveyor chain at least over some sections along the conveying path. A large number of first conveying means and second conveying means can thus also be driven in a straightforward and reliable manner.

The conveyor chain can be constituted as an endless loop.

The conveyor chain, in particular a conveyor chain constituted as an endless loop, can be driven as required with only one drive module or with a small number of drive modules, which reduces the cost of acquisition and maintenance of such an embodiment of a conveying system according to the invention compared to many conventional systems.

In an embodiment of the invention, the conveying path comprises a conveyor rail for the direct or indirect guidance of the at least one first conveying means and the at least one second conveying means. In particular, support elements of an assembled conveying support, as well as trays, can be guided directly or indirectly in a reliable and precise manner. A straightforward assembly of the conveying system can thus also be achieved.

Provision can be made such that the support elements of the at least one first conveying means, as well as of the at least one second conveying means, are each connected by a fastening means to conveying elements which can be moved and are guided along the conveyor rail. In particular, at least one assembled conveying support and at least one tray can each be connected by a fastening means to conveying elements which can be moved and guided along the conveyor rail. It is also possible for at least individual first conveying means and/or second conveying means not to be connected by fastening means to conveying elements which can be moved and guided along the conveyor rail.

In an embodiment of the conveying system according to the invention, the support elements and/or the fastening means are constituted such that both a support element and also a tray can optionally be fastened to them. A particularly cost-effective structure of such a conveying system, as well as a straightforward replacement of defective parts and/or a simple adaptation of the conveying system to changed requirements are thus possible.

A particularly energy-efficient conveying system can be achieved if required, when the conveying elements each comprise a conveying carriage. Such a conveying carriage can comprise a running roller or a plurality of running rollers, which run on a running surface or on a plurality of running surfaces of the conveyor rail. A particularly low-noise and low-friction conveyance even of heavy items to be conveyed can thus be achieved.

A particularly versatile conveying system can be achieved if the conveyor rail encloses a channel running in the rail direction and the conveying carriages are guided in the channel as inner runners. Soiling of the conveying carriages and/or of running surfaces of the conveyor rail can thus be reduced.

The number of openly inaccessible moving parts of the conveying system can thus also be reduced, as a result of which the risk of injury to users can be reduced.

A conveying carriage can in particular comprise running rollers (for example support rollers) which roll along running surfaces in a channel of the conveyor rail running in the rail direction. Particularly good results can be achieved if a conveying carriage comprises at least one guide roller and at least two running rollers, as will be shown in greater detail below.

Such conveying carriages can be used equally for conveying support elements of an assembled conveying support, as was for conveying trays. Conveying systems with different sequences of assembled conveying supports and trays can thus be constructed in a straightforward manner, defective components can be replaced and existing systems rapidly extended and/or adapted to new conveyor requirements. It is also thus possible to combine different kinds of assembled conveying supports and/or different kinds of trays with one another in a straightforward manner in a conveying system.

In one embodiment of the conveying system, the conveying carriages each comprise precisely two running rollers and each form a chain-link of a conveyor chain, in particular of a conveyor chain constituted as an endless loop.

According to an embodiment of the invention, the conveying carriages are guided in the channel as inner runners and can be operatively connected to one another mechanically, so that they can form a conveyor chain, in particular a conveyor chain constituted as an endless loop. For this purpose, the conveying carriages can be connected for example by means of link joints—in particular by means of ball-and-socket joints.

Such a conveyor chain formed by conveying carriages running in a channel (also called a channel chain) enables a particularly high degree of freedom of design in the spatial routing of the conveying path. Amongst other things, this is because the conveying carriages can advantageously transfer to the conveyor rail the forces and moments exerted on them by for example support elements or trays. With such an embodiment of a conveying system according to the invention, helical portions, for example, can also be integrated into the conveying path in a straightforward manner. Conveying paths can thus also be formed in a straightforward manner which extend over a plurality of planes markedly spaced apart from one another in the vertical direction.

According to an embodiment of the conveying system, the support elements of an assembled conveying support can each comprise at least one element conveying surface for the conveying of items to be conveyed that are lying thereon. A plurality of support elements can thus form a segment sequence. A support element can for example be a carrier plate.

A conveying system particularly suitable for accommodating especially heavy items to be conveyed can be achieved if support elements of an assembled conveying support that are adjacent to one another at least partially overlap, so that their element conveying surfaces form a combined conveying support.

According to an embodiment of the conveying system, a tray comprises a tray plate with a tray conveying surface, wherein the tray plate is connected to a tilting device, which can tilt the tray plate in a first rotational direction about a tilting axis arranged parallel to the conveying direction of the conveying path from a transport position into a first unloading position, in order to unload an item to be conveyed lying on the tray conveying surface in a first direction transversely to the conveying direction. Straightforward unloading of the tray is thus enabled, without the item to be conveyed having to be gripped for example by an external unloading device.

Alternatively or in addition to the unloading by means of a tilting device, the unloading of an item to be conveyed from a tray can however also at least be assisted, for example, by active gripping and/or engagement by suction and/or by means of an (electro-) magnetic connection.

According to an embodiment of the invention, the tray conveying surface of a tray is at least partially curved, or shell-shaped. The risk of slipping and/or rotating of certain items to be conveyed during the conveying process can thus also be reduced. A defined positioning of the item to be conveyed on the tray can thus be achieved or at least assisted if need be.

A particularly versatile and also modular conveying system can be achieved with an embodiment of the invention, wherein the tray plate of a tray can be tilted about the tilting axis from the transport position into a second unloading position, in order to unload an item to be conveyed lying on the tray conveying surface transversely to the conveying path in a second lateral direction.

Simple tilting of the tray plate can be achieved if the tilting device comprises a control element, by means of which the tray plate is tilted into the first or second unloading position in an interaction with a control slide-way, as will be explained in greater detail below.

According to an embodiment of the invention, the tray conveying surface of a tray is surrounded at least partially by a retention frame. Such an embodiment is particularly suitable for preventing slipping or rolling away of the item to be conveyed from the tray on curved and/or descending/ascending sections of the conveying path. A retention frame can be constituted in one piece or multi-piece

A retention frame can for example be connected fixedly to the tray conveying surface of a tray—or rather the tray plate, or can be displaceable with respect to the tray conveying surface, as will be explained in greater detail below. A retention frame and a tray plate can in particular also be constituted in one piece. A tray can also comprise an optional marker, by means of which a tray and/or an item to be conveyed lying on a tray can be unequivocally identified.

An assembled conveying support can also comprise an optional marker, by means of which the assembled conveying support and/or an item to be conveyed lying on the assembled conveying support, or lying in a specific region of the assembled conveying support, can be unequivocally identified.

An RFID tag or an optical marking such as lettering or a barcode can be used as a marker. The use of a plurality of markers of the same kind or of different kinds is also possible.

Alternatively or in addition, information can be stored in a marker (in particular an RFID tag) before and/or during and/or after the loading of a transport means with an item to be conveyed, in particular information as to the nature of the item to be conveyed and/or as to the identity of the item to be conveyed and/or as to the loading procedure and/or as to the destination of the item to be conveyed.

Alternatively or in addition, one marker or a plurality of markers can also provide information concerning specific properties of the first or second conveying means. In particular, a marker can provide information concerning the bearing capacity and/or the spatial dimensions of a first or second conveying means, in particular of a tray.

An assembled conveying support can also comprise one or more markers which provide information concerning the remaining distance up to at least one end of the assembled conveying support and/or the total length of the assembled conveying support. Such information can be used for example to load the conveying support more efficiently and therefore to optimise the conveying capacity of a conveying system.

Alternatively or in addition, the information provided by a marker can be used to retrieve specific information from a database, in particular information concerning an item to be conveyed that is conveyed by the first or second conveying means and/or information (e.g. dimensions and/or bearing capacity) concerning the conveying means in question.

According to an embodiment of the invention, the conveying system comprises at least one conveying support composed of a number of successive support elements, which conveying support comprises a marker extending over the successive support elements. A particularly efficient use of the conveying support can thus be achieved, since the distances to the two ends of the conveying support, for example, can thus be determined particularly easily and precisely. Alternatively or in addition, individual markers can also be applied on each, on every other, on every third or in general on every i-th (i=1, 2, 3, . . . N) support element.

Straightforward and careful unloading of the item to be conveyed can be achieved if the retention frame is configured such that it can be raised or lowered relative to the tray conveying surface during the tilting of the tray plate, in order to facilitate sliding of the item to be conveyed from the tray conveying surface for the purpose of unloading.

According to an embodiment of the invention, at least two trays arranged directly one behind the other on the conveying path form a composition of trays. By means of such a composition, prompt loading, conveying, unloading and/or further processing of a plurality of items to be conveyed can be achieved as required.

The number of trays in a composition can be selected according to an embodiment of the conveying device, such that the mechanical load exerted by the trays of a composition on the conveyor rail cannot exceed a defined maximum permissible loading.

Alternatively or in addition to this, individual trays or compositions of trays can also be arranged or spaced apart with respect to one another in such a way that, in the given routing of the conveying system, simultaneously occurring conveyance of heavy items to be conveyed on ascending sections and/or curved sections of the conveying path cannot take place. Load peaks acting on a conveyor chain and/or on a section of the conveying path and/or on a drive module can thus be reduced. According to such an embodiment of the invention, therefore, assembled conveying supports and trays of the conveying system are arranged with respect to one another in such a way that their sequence is adapted to the spatial routing of the conveying system, in order to reduce load peaks during conveying. If required, a drive having a lower power can thus also be used, which can be economically and/or ecologically advantageous.

According to an embodiment of the invention, the conveying system comprises a plurality of compositions of trays, which are arranged along the conveying path in each case at a distance from one another. A conveying system with constant expected waiting and conveying times can thus be achieved. The distances between the compositions can be constant or variable depending on the use.

According to a further embodiment of the invention, the conveying system comprises a loading device for loading a first conveying means, for example an assembled conveying support, with an item to be conveyed. Such a first loading device can for example be a conveyor belt running laterally towards the conveying path.

According to a further embodiment of the invention, the conveying system comprises a second loading device for loading a second conveying means, for example a tray located in a conveying position.

According to an embodiment of the invention, the first and the second loading device are identical, i.e. the conveying system comprises a mixed loading device, which is suitable both for loading a first conveying means, in particular an assembled conveying support, and also for loading a second conveying means, in particular a tray located in a conveying position.

In an embodiment, the conveying system comprises a first unloading device for unloading an item to be conveyed from the assembled conveying support. The unloading can take place in particular in a lateral direction away from the assembled conveying support, but unloading in a vertical direction, for example, is also possible. Unloading in a plurality of different directions is possible.

According to the invention, it is possible for the conveying system to comprise a plurality of first unloading zones, which can comprise a plurality of identical and/or different kinds of unloading devices.

An embodiment of the conveying system with a first unloading device, which can be used for a plurality of items to be conveyed, can be achieved if the first unloading device comprises a pushing device, which can be moved in transversely to the conveying direction of the conveying path into the conveying region of the conveying path, in order to displace an item to be conveyed lying on an assembled conveying support transversely to the conveying direction and thus to unload the assembled conveying support.

Alternatively or in addition, a conveying system can also comprise a rejection element (or deflection element), which can be moved into the conveying region of the conveying path, so as to be able to deflect an item to be conveyed lying on an assembled conveying support transversely to the conveying direction and thus to unload the assembled conveying support, while the item to be conveyed is moving in the conveying direction.

In the context of the present application, “transversely to the conveying direction” means at a specific angle to the conveying direction of the conveying device. The angle can in particular amount to 90 angular degrees.

In an embodiment of the invention, the conveying system comprises a second unloading device for unloading an item to be conveyed from a second conveying means, in particular from a tray.

Simple unloading of a tray can be achieved if the second unloading device comprises a control slide-way for controlling the unloading of the tray. Such a control slide-way can for example, as mentioned above, interact with a control element arranged on the tray, in order to control a tilting process for delivering an item to be conveyed that is conveyed by the tray.

A control slide-way may be activatable and deactivatable, so that a tray can be unloaded or not unloaded as required at a second unloading device.

If need be, a plurality of first and/or second unloading devices can be arranged in one or in a plurality of spatially combined unloading zones.

At least one or a plurality of onward or removing conveying devices can be assigned to a first or a second unloading device. Alternatively or an addition, a collecting device can be assigned to an unloading device, in which collecting device the unloaded items to be conveyed are collected and at least temporarily stored.

According to an embodiment of the invention, the conveying device comprises at least one sensor, which detects whether a specific first and/or a second conveying means is occupied by an item to be conveyed, in particular whether a specific section of an assembled conveying support or a specific tray is occupied by an item to be conveyed.

Alternatively or in addition, a sensor can also determine whether a conveying unit (or conveying means) at a specific location of the conveying path is a first or a second conveying unit (or a first or second conveying means), and/or can determine the identity of a tray.

Alternatively or in addition, a sensor can detect the nature and/or the size and/or the weight and/or the assigned destination of an item to be conveyed that is conveyed by the conveying system. As sensors, use may be made for example of optical sensors (e.g. cameras, light barriers, laser scanners) or also acoustic sensors (e.g. ultrasound systems) or antennae (e.g. for RFID).

Alternatively in addition, a sensor can also determine whether an item to be conveyed is being conveyed on a section of the assembled conveying support or on a tray, in order for example to activate an unloading device corresponding to the latter.

A method according to the invention for operating a conveying system according to the invention usually comprises the following steps:
providing the conveying system;
loading of the at least one first conveying means with a first item to be conveyed; and/or
loading of the at least one second conveying means with a second item to be conveyed;
conveying of the at least one first conveying means along the conveying path to a first unloading device and unloading of the first item to be conveyed; and/or
conveying of the at least one second conveying means to a second unloading device and unloading of the second item to be conveyed in an unloading station.

According to an embodiment of the method, the at least one first conveying means and/or the at least one second conveying means comprises a tray, which is brought into a loading position before the loading step and/or is held in a loading position during the loading.

According to an embodiment of the method, the first or the second item to be conveyed is unloaded by a pushing procedure transversely to the conveying direction. Straightforward and careful unloading of the first or second item to be conveyed from a conveying support composed of a number of successive support elements is enabled.

A further embodiment of the method also comprises the following process steps:
supplying of an object to be conveyed;
classification of the object as a first item to be conveyed or as a second item to be conveyed.

Such a classification can take place on the basis of the nature of the object. Piece goods, such as for example larger objects or combinations of a plurality of smaller objects packaged in cases or in some other way can thus be classified for example as first items to be conveyed and can be loaded onto a section of an assembled conveying support or on a tray of a larger size. Bulk goods or smaller items, which could not be conveyed reliably and/or carefully on the assembled conveying support on account of their shape and/or their weight and/or their surface properties, can for example be classified as second items to be conveyed and can be loaded onto a tray having a specific/matching size.

Alternatively or in addition, the classification of the items can take place on the basis of their size and/or weight.

According to a further embodiment of the method, it is determined, before the loading of a first and/or a second conveying means, in particular an assembled conveying support and/or a tray, whether such loading would not lead to a critical mechanical loading of the conveying system. For this purpose, it can for example be ascertained how the sections of the conveying system adjacent to a first or second conveying means (respectively the assembled conveying support or the tray) are already loaded with items to be conveyed. Such a determination can take place for example by means of a mechanical device for the weight measurement of the items to be conveyed and/or the measurement of the deformation of a conveyor rail and/or of a tray and/or of a support element. Alternatively or in addition, optical sensors can also be used for this purpose. In this way, damage to the conveying device due to mechanical overload caused by items to be conveyed not being distributed uniformly can be prevented.

According to an embodiment of the invention, a conveying system according to the invention can however also be operated at least temporarily in such a way that an item to be conveyed is conveyed only on conveying supports or that an item to be conveyed is conveyed only on trays.

### BRIEF DESCRIPTION OF SEVERAL VIEWS OF THE DRAWINGS

Aspects of the invention are explained in greater detail with the aid of the examples of embodiment shown in the following figures and the associated description. In the figures, diagrammatically:

FIG. 1 shows an embodiment of a conveying system according to the invention in a plan view;

FIG. 2 shows an embodiment of an assembled conveying support according to the invention with a plurality of items to be conveyed that are conveyed thereon in a perspective view from above,

FIG. 3 shows an embodiment of an assembled conveying support comprising two support elements in a perspective view from above;

FIG. 4 shows an assembled conveying support according to the embodiment from FIG. 3 in a frontal view;

FIG. 5 shows a first embodiment according to the invention of two trays which are constituted as tilting trays, in a perspective view from above;

FIG. 6 shows a second embodiment of a tray according to the invention in a frontal view;

FIG. 7 shows the embodiment of the tray from FIG. 6 in a tilted state;

FIG. 8 shows an embodiment of a conveying system according to the invention in a plan view;

FIG. 9 shows an embodiment of an unloading device with a pushing device in a plan view;

FIG. 10 shows an embodiment of a conveying system according to the invention in a plan view;

FIG. 11 shows an embodiment of a conveying system according to the invention in a plan view.

### DETAILED DESCRIPTION OF THE INVENTION

Corresponding parts are provided with identical reference numbers, unless indicated otherwise, in the following figures and the associated description.

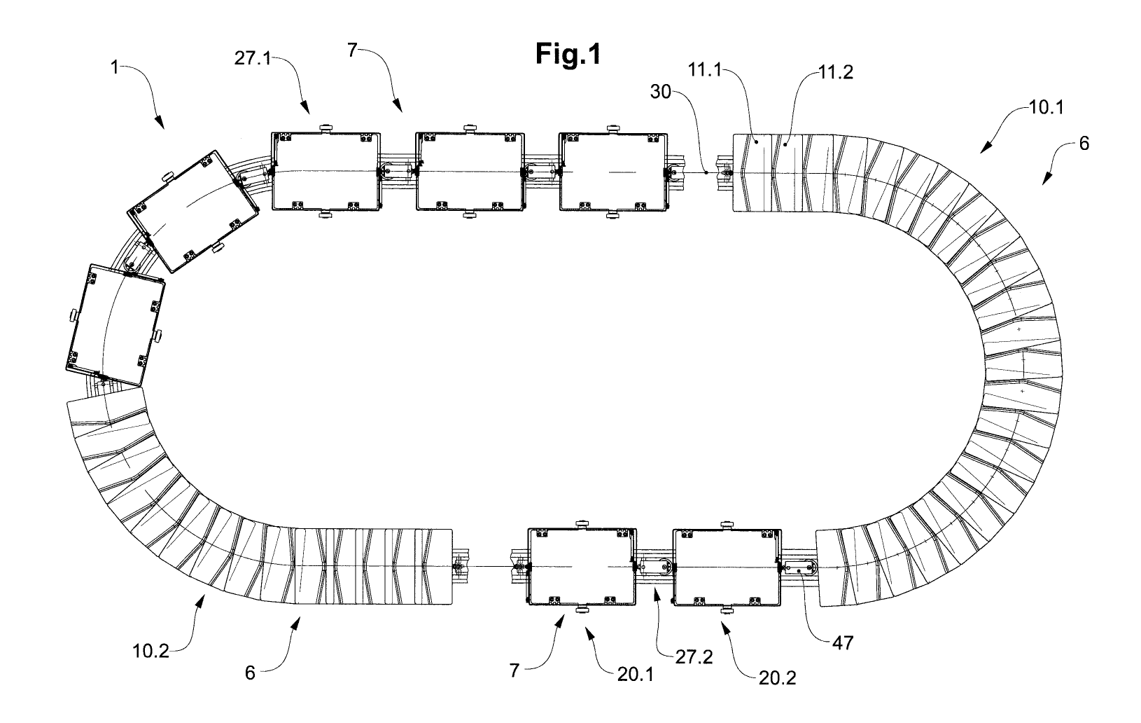

FIG. 1 shows diagrammatically an embodiment of a conveying system 1 according to the invention comprising two assembled conveying supports 10.1, 10.2, which can be moved along a conveying path 30 and which represent first conveying means 6. For the purpose of better illustration, conveying path 30 is represented interrupted. Assembled conveying supports 10.1, 10.2 are each composed of a number of successive support elements 11.1, 11.2. In the embodiment shown, the two conveying supports 10.1, 10.2 are constituted differently (not represented). A first conveying support 10.1 can be formed for example from a highly heat-resistant material, so that relatively hot items to be conveyed can be conveyed with it. Second conveying support 10.2, on the other hand, can comprise for example a surface made a plastic material with a high static friction coefficient, so that certain large items to be conveyed can be transported reliably. The two assembled conveying supports 10.1, 10.2 serve to convey items to be conveyed (not represented) lying freely on the latter. Shown conveying system 1 also comprises a plurality of trays 20.1, 20.2, which in the embodiment shown are combined as compositions of trays 27.1, 27.2 and serve as second conveying means 7. Trays 20.1, 20.2 are connected by a common conveyor chain 47 to assembled conveying supports 10.1, 10.2 and can thus be moved with the latter along conveying path 30. Trays 20.1, 20.2 serve to convey second items to be conveyed (not represented) lying on them.

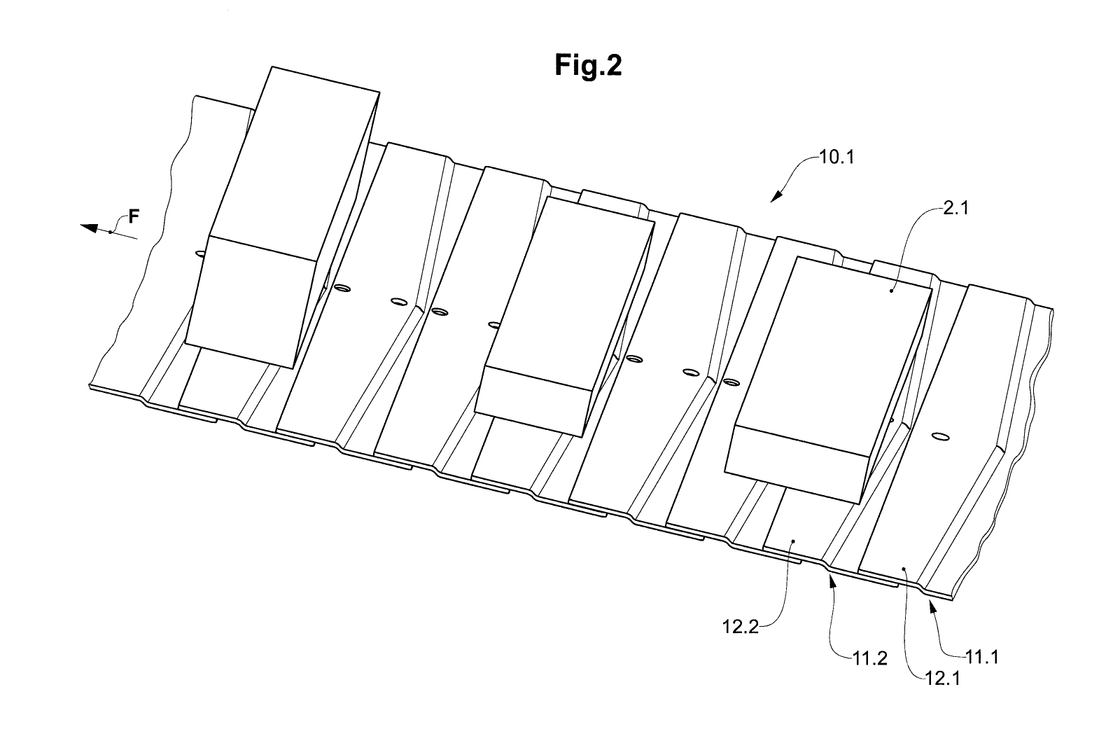

FIG. 2 shows diagrammatically an embodiment of an assembled conveying support 10.1 according to the invention. The latter is constituted in the manner of a chain conveyor comprising a plurality of plate-shaped support elements 11.1, 11.2. Support elements 11.1, 11.2 each comprise on their upper surface an element surface 12.1, 12.2 for conveying an item 2.1 to be conveyed lying thereon in conveying directions F. Support elements 11.1, 11.2 are formed and arranged scale-like with respect to one another, in such a way that support elements 11.1, 11.2 lying adjacent to one another partially overlap. An assembled mobile conveying surface thus arises, which as shown also enables the conveying of larger items to be conveyed.

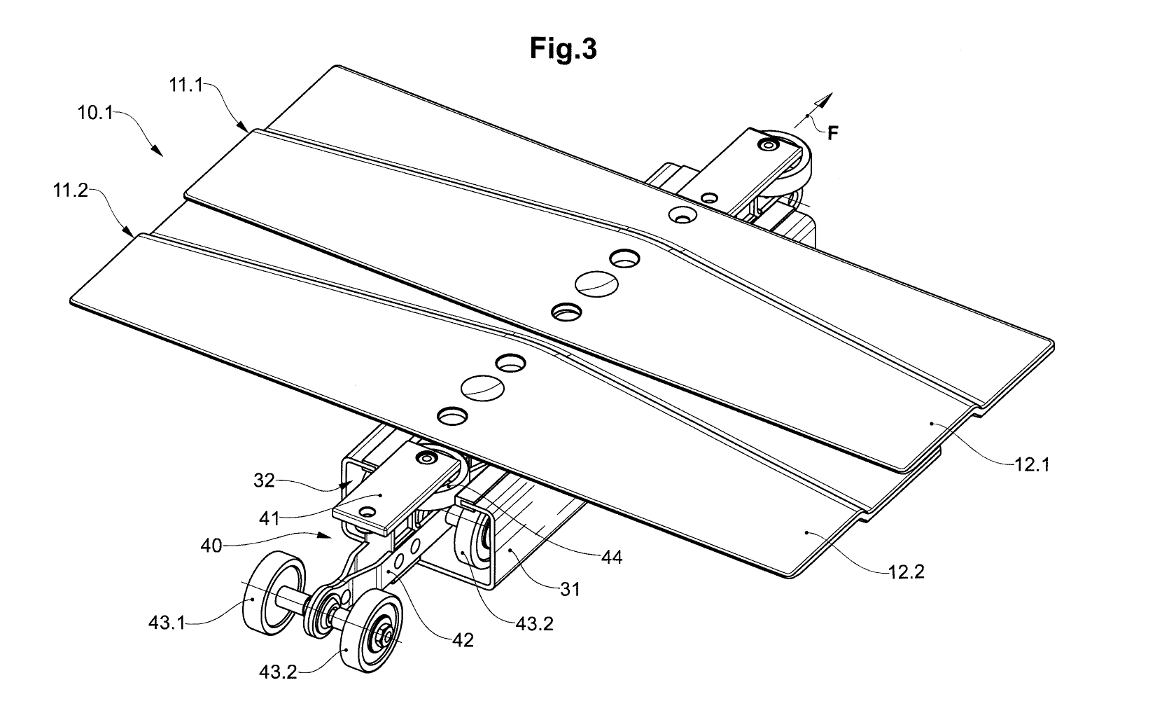

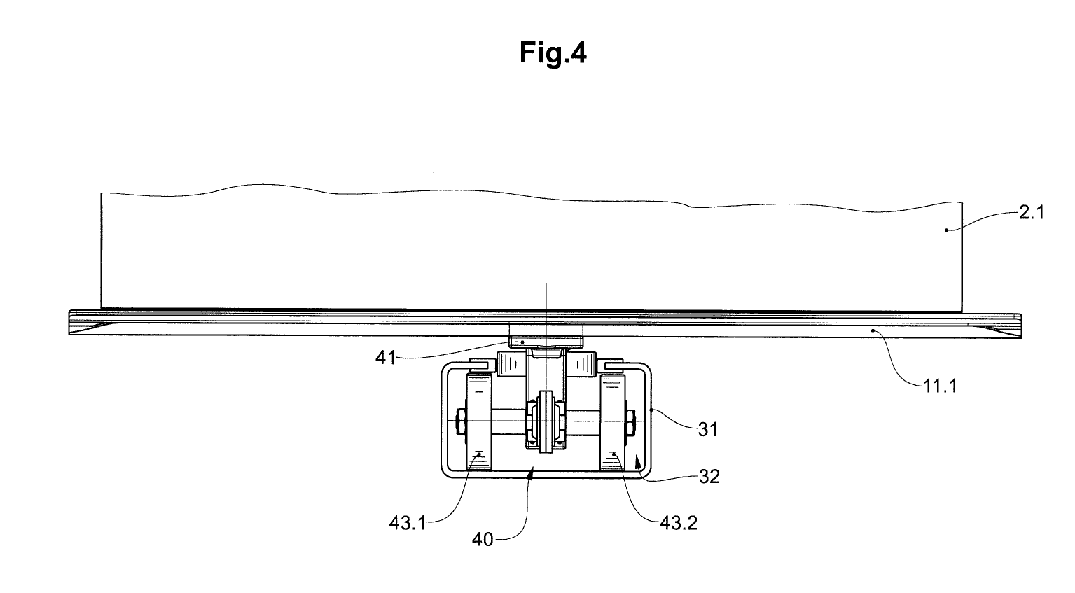

FIGS. 3 and 4 show an embodiment of the invention, wherein support elements 11.1, 11.2 of an assembled conveying support 10.1 are each connected by fastening means 41 to conveying elements 40 which can be moved and are guided along a C-shaped conveyor rail 31. Conveying elements 40 each comprise a conveying carriage 42. This conveying carriage 42 is arranged as an inner runner in a channel 32 in conveyor rail 31, said channel running in the rail direction, and comprises in the shown embodiment two support rollers 43.1, 43.2, which roll on running surfaces in channel 32. Shown conveying carriages 42 also comprise guide rollers 44, which roll on further guide surfaces of conveyor rail 31 and at least assist the conveying of conveying carriages 42 along conveying path 30.

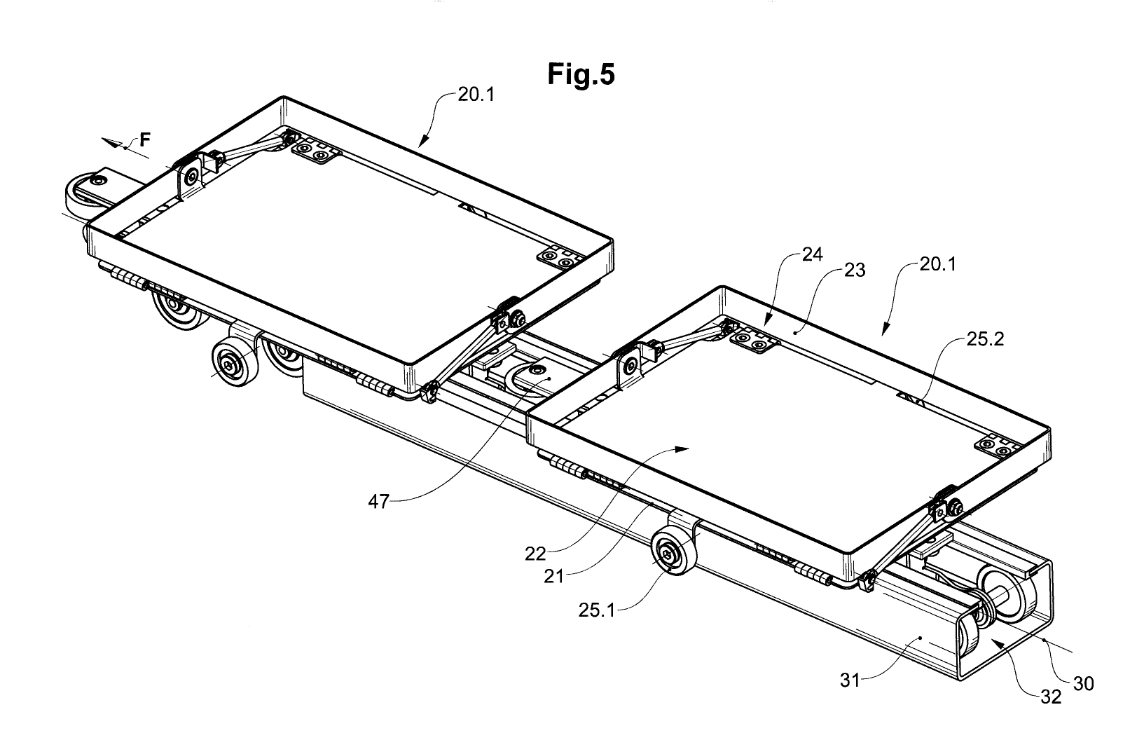

FIG. 5 shows a composition 27 of two trays 20.1 of a first type, which are connected by a conveyor chain 47 guided in a conveyor rail 31 and formed from a plurality of conveying carriages 42. Both trays 20.1 are in a transport position. A tray 20.1 of the represented embodiment comprises in each case a tray plate 21, which comprises a flat tray conveying surface 22, on which an item to be conveyed (not represented) can be loaded. Tray plate 21 is connected to a tilting device 24 (only partially visible), which can tilt tray plate 21 about a tilting axis arranged parallel to conveying direction F of conveying path 30 from the transport position into a first or second unloading position, in order to unload an item to be conveyed lying on tray conveying surface 22 transversely to conveying path 30. For the control of the tilting, shown tray 20.1 comprises on each side a control element 25.1, 25.2 constituted as a roller, by means of which tray plate 21, interacting with a control slide-way (not represented) arranged along conveying path 30, can be tilted into a first or second unloading position. Tray 20.1 of the first type shown in FIG. 5 also comprises a two-part retention frame 23, which prevents an item to be conveyed lying on tray conveying surface 22 from slipping or rolling undesirably from tray 20.1. Retention frame 23 is configured such that it can be raised relative to tray conveying surface 22 during the tilting of tray plate 21, as a result of which the delivery of an item to be conveyed located on tray conveying surface 22 is assisted by sliding off.

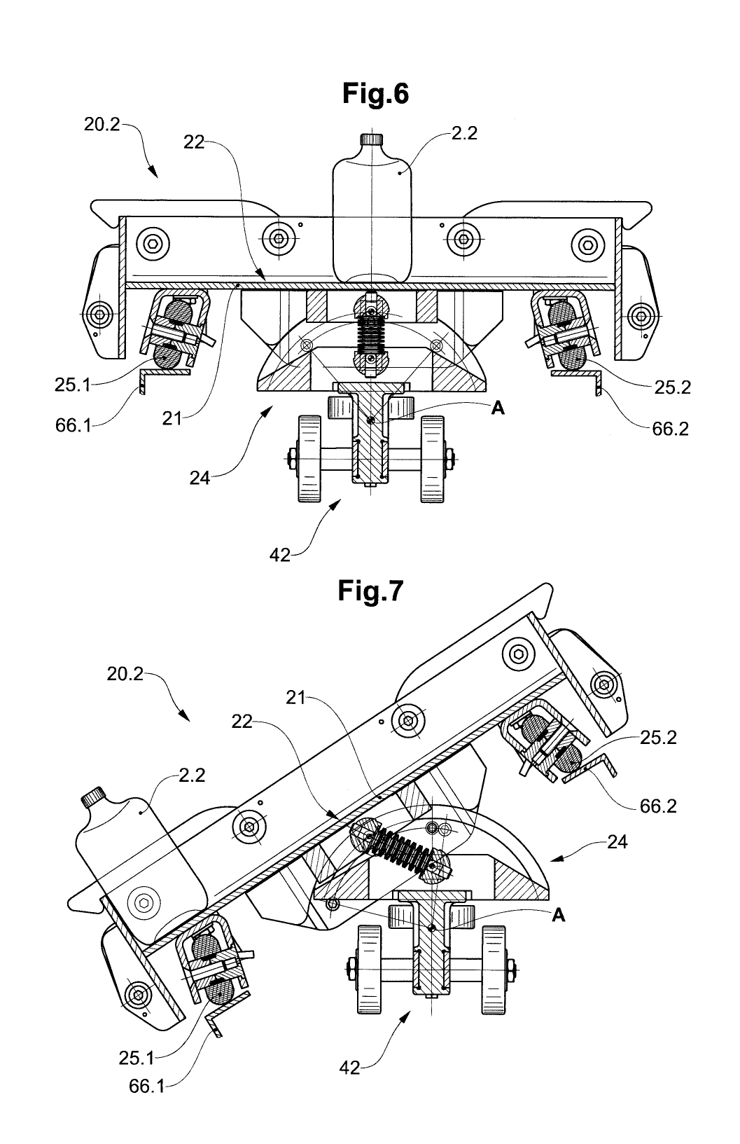

FIGS. 6 and 7 show an embodiment of a tray 20.2 of a second type for a conveying system 1 according to the invention. FIG. 6 shows tray 20.2 in a transport position. Tray 20.2 comprises a tray plate 21 with a tray conveying surface 22, on which an item 2.2 to be conveyed is arranged. Tray plate 21 is connected by a tilting device 24 to a conveying carriage 42. Tilting device 24 comprises a control element 25.1, 25.2 comprising two rollers. The rollers of control element 25.1, 25.2 each run on control slide-ways 66.1, 66.2 assigned to the conveying path. In order to keep tray 20.2 in the transport position, control slide-way 66.1, 66.2 can be aligned relative to the conveying path in such a way that tray conveying surface 22 lies essentially horizontally, as is represented in FIG. 6.

FIG. 7 shows a tray 20.2 in an unloading position. To obtain the latter, tray plate 21 has been tilted by means of tilting device 24 about a tilting axis A arranged parallel to the conveying direction of the conveying path. This tilting process has been initiated, as represented, by the interaction of control elements 25.1, 25.2 with control slide-ways 66.1, 66.2.

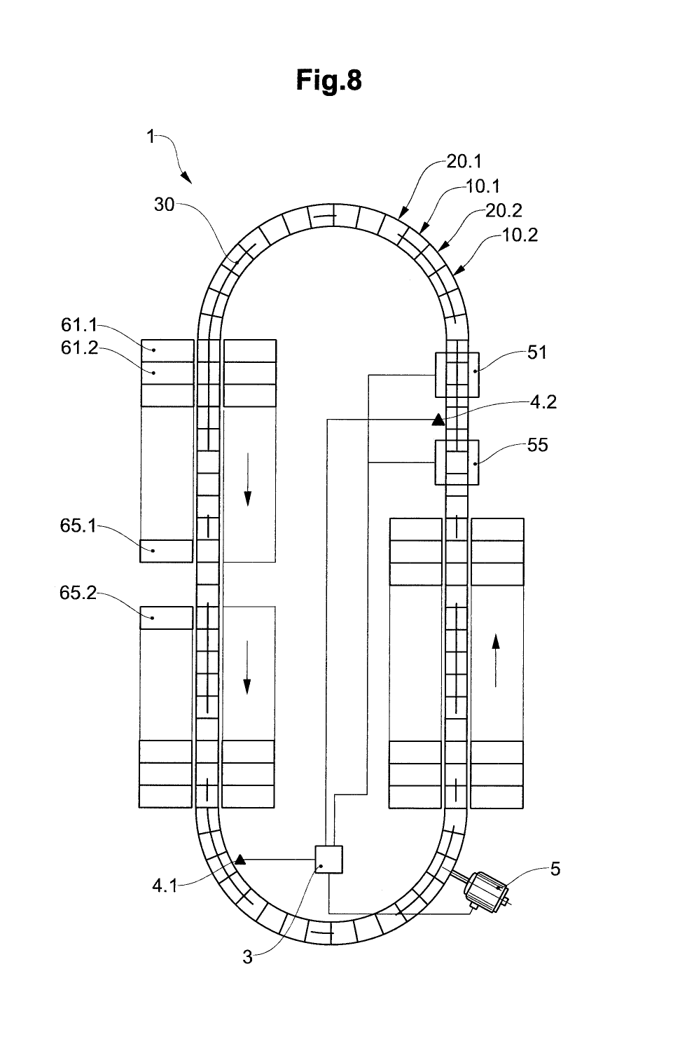

FIG. 8 shows an embodiment of a conveying system 1 with a closed conveying path 30, along which a number of assembled conveying supports of different kinds/types 10.1, 10.2 as well as trays of different kinds/types 20.1, 20.2 (assembled conveying supports and trays are not represented in detail) are moved. Assembled conveying supports 10.1, 10.2 and trays 20.1, 20.2 are driven by a conveyor chain (not represented) constituted as an endless loop, which for its part is driven by a central drive module 5. Conveying system 1 also comprises sensors 4.1, 4.2, which detect the loading of assembled conveying supports 10.1, 10.2 and trays 20.1, 20.2 conveyed past them. Conveying system 1 also comprises a first loading device 51 for loading assembled conveying supports 10.1, 10.2 with items to be conveyed (not shown). Conveying system 1 also comprises a second loading device 55 for loading trays 20.1, 20.2 with items to be conveyed (not shown). Sensors 4.1, 4.2, drive module 5 and the two loading devices 51, 55 are controlled by a control 3. Three unloading zones with first unloading devices 61.1, 61.2 for unloading assembled conveying supports 10.1, 10.2 and/or second unloading devices 65.1, 65.2 for unloading trays 20.1, 20.2 are arranged along conveying path 30. Trays 20.1, 20.2 also comprise markers (not represented), with the aid of which the nature of tray 10.1, 10.2 and/or the identity (e.g. number) of tray 10.1, 10.2 and/or the item to be conveyed that is conveyed by the latter can be determined by means of sensors 4.1, 4.2.

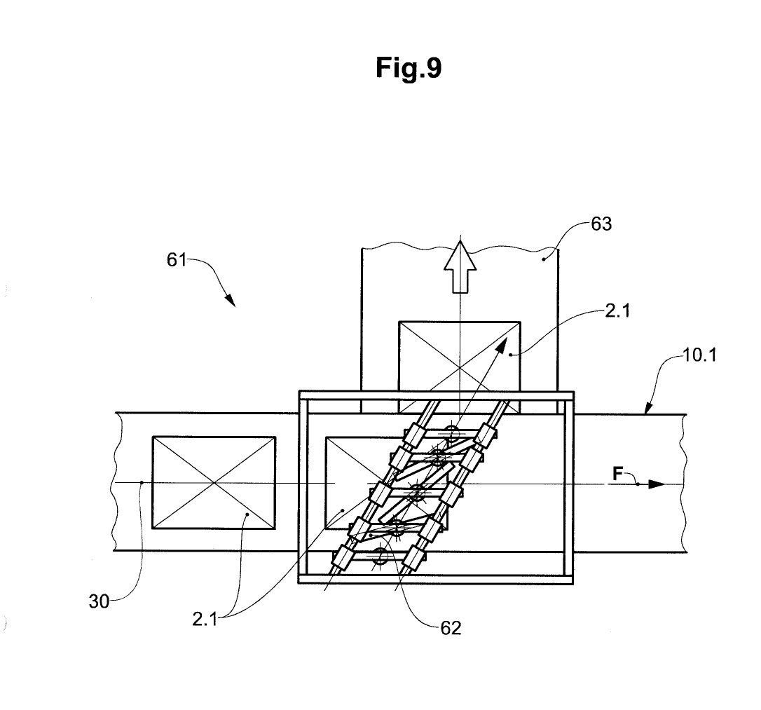

FIG. 9 shows diagrammatically an embodiment of a first unloading device 61 for the lateral unloading of items 2.1 to be conveyed from an assembled conveying support 10.1. Unloading device 61 also comprises a pushing device 62, which can be moved in transversely to conveying direction F of conveying path 30 into the conveying region of conveying path 30, in order to displace an item 2.1 to be conveyed lying on assembled conveying support 10.1 transversely to the conveying direction onto a removing conveying device 63 and thus to unload assembled conveying support 10.1.

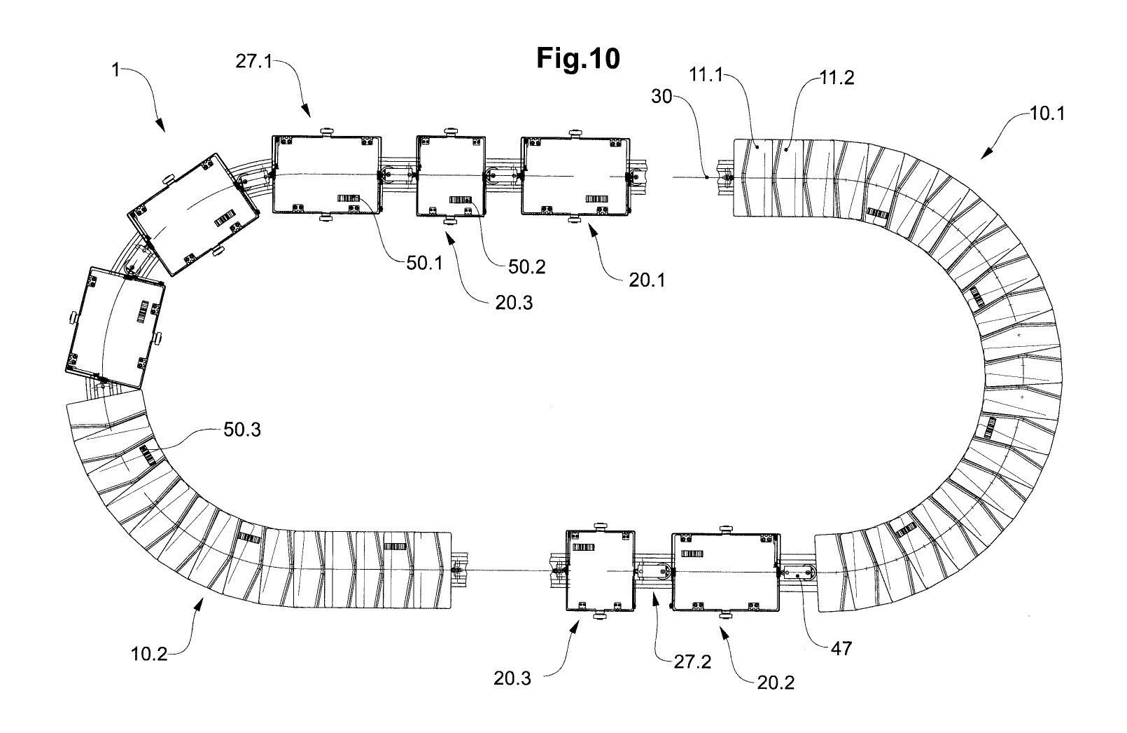

FIG. 10 shows diagrammatically an embodiment of a conveying system 1 according to the invention similar to the embodiment of a conveying system 1 represented in FIG. 1. Shown conveying system 1 comprises a plurality of trays 20.1, 20.2, 20.3, which in the shown embodiment are combined as compositions of trays 27.1, 27.2 and serve as a second conveying means. As represented diagrammatically, conveying system 1 comprises both trays 20.1, 20.2 with a spatial extension that is greater in the conveying direction and trays 20.3 with a special extension which is smaller in the conveying direction compared to the other trays 20.1, 20.2. In this way, two items to be conveyed (not represented) with different external dimensions can be transported on trays of suitable size, and at the same time the conveying capacity of conveying system 1 compared to conveying system 1 shown in FIG. 1 can also be increased for a plurality of applications. The combination of a composition of trays 20.1, 20.2, 20.3 can take place depending on the items to be conveyed by conveying system 1. In addition, the represented embodiment of conveying system 1 according to the invention comprises assembled conveying supports 10.1, 10.2 which are able to be moved and which represent first conveying means. Markers 50.3 spaced uniformly apart from one another are applied on assembled conveying supports 10.1, 10.2, which markers in this case are RFID tags with barcodes and lettering. The latter provide, amongst other things, a loading device (not represented) with information concerning the loading capacity of respective conveying supports 10.1, 10.2 and the remaining distance to at least one end of the conveying support. In this way, it can be ensured, for example before the loading of a particularly large item to be conveyed, that there is in fact still sufficient room on conveying support 10.1, 10.2 to accommodate the item to be conveyed. As represented diagrammatically, trays 20.1, 20.2 with the spatial extension that is larger in the conveying direction comprise markers 50.1, which in this embodiment are also RFID tags with barcodes and lettering. Trays 20.3 with the spatial extension that is smaller in the conveying direction also comprise markers 50.2. These markers 50.1, 50.2 can contain various retrievable information, for example concerning the mechanical and spatial conveying capacity of individual trays 20.1, 20.2, 20.3, and also concerning the item to be conveyed that is conveyed on the latter.

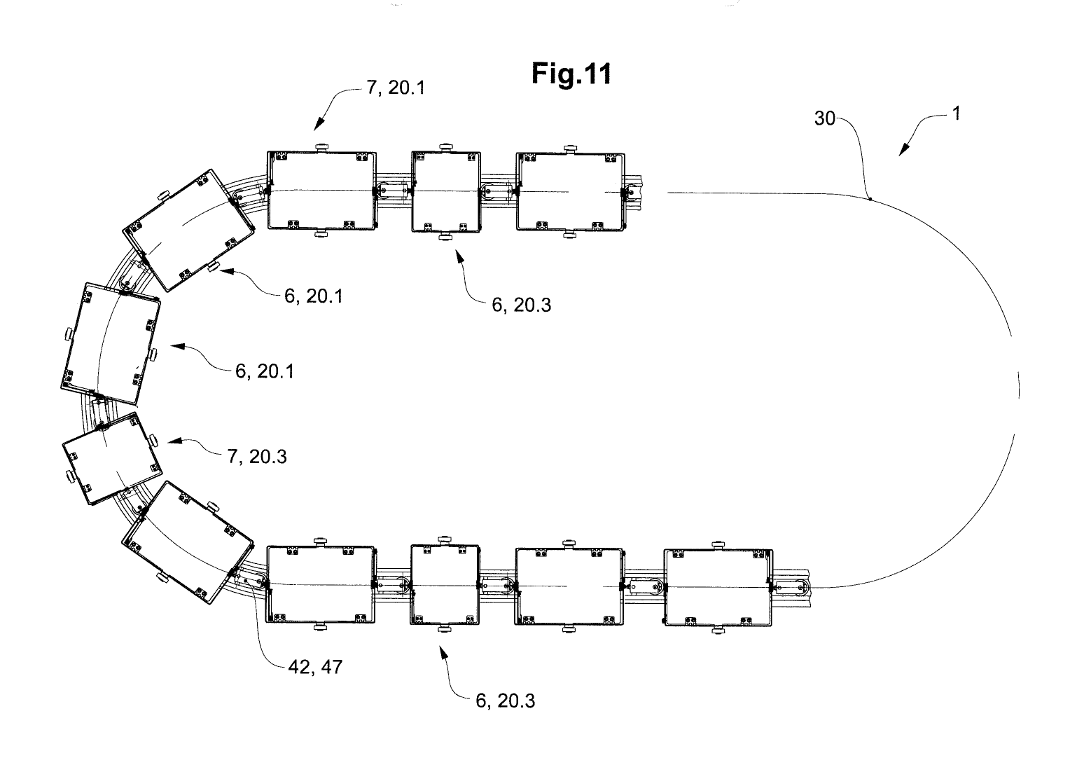

FIG. 11 shows diagrammatically an embodiment of a conveying system 1 according to the invention, which comprises a plurality of first conveying means 6, which can be moved along conveying path 30 and which comprise trays 20.3 with a rather small spatial extension in the conveying direction. Conveying system 1 also comprises a plurality of second conveying means 7, which can be moved along conveying path 30 together with first conveying means 6, or trays 20.3, and which comprise trays 20.1 with a spatially larger extension in the conveying direction compared to first conveying means 6. First conveying means 6 are configured in particular for conveying a relatively small first item to be conveyed, whereas second conveying means 7 are configured for conveying a second item to be conveyed that is larger compared to the first item to be conveyed. The first and the second conveying means are connected by conveying carriages 42, which together form a conveyor chain 47.

1. A conveying system (1) for conveying items (2.1, 2.2) to be conveyed, comprising
a. a conveying path (30);
b. at least one first conveying means (6) which can move along the conveying path (30) and is configured for conveying a first item (2.1) to be conveyed; and
c. at least one second conveying means (7) which can move along the conveying path (30) together with the at least one first conveying means (6), wherein the at least one second conveying means (7) is configured for conveying a second item (2.2) to be conveyed that is different in nature from the first item (2.1) to be conveyed.

2. The conveying system (1) according to claim 1, wherein the conveying path (30) is constituted as an endless loop.

3. The conveying system (1) according to claim 1, wherein the at least one first conveying means (6) and the at least one second conveying means (7) are driven by a conveyor chain (47) at least over some sections along the conveying path (30).

4. The conveying system (1) according to claim 1, wherein the conveying path (30) comprises a conveyor rail (31) for the direct or indirect guidance of the at least one first conveying means (6) and the at least one second conveying means (7).

5. The conveying system (1) according to claim 4, wherein the at least one first conveying means (6) as well as the at least one second conveying means (7) are each connected by a fastening means (41) to conveying elements (40) which can be moved and are guided along the conveyor rail (31).

6. The conveying system (1) according to claim 5, wherein the conveying elements (40) each comprise a conveying carriage (42).

7. The conveying system (1) according to claim 6, wherein the conveyor rail (31) encloses a channel (32) running in the rail direction and the conveying carriages (42) are guided in the channel (32) as inner runners.

8. The conveying system (1) according to claim 1, wherein the at least one first conveying means (6) comprises at least one conveying support (10.1, 10.2) including a number of successive support elements (11.1, 11.2) for conveying a first item (2.1) to be conveyed lying freely on the assembled conveying support (10.1, 10.2) or that the at least one first conveying means (6) comprises at least one tray (20.1, 20.2, 20.3) for conveying a first item (2.1) to be conveyed lying on the tray (20.1, 20.2, 20.3).

9. The conveying system (1) according to claim 1, wherein the at least one second conveying means (7) comprises at least one conveying support (10.1, 10.2) including a number of successive support elements (11.1, 11.2) for conveying a second item (2.2) to be conveyed lying freely on the assembled conveying support (10.1, 10.2) or that the at least one second conveying means (7) comprises at least one tray (20.1, 20.2, 20.3) for conveying a second item (2.2) to be conveyed lying on the tray (20.1, 20.2, 20.3).

10. The conveying system (1) according to claim 9, wherein the at least one first conveying means (6) comprises a conveying support (10.1, 10.2) including a number of successive support elements (11.1, 11.2) for conveying a first item (2.1) to be conveyed lying freely on the assembled conveying support (10.1, 10.2) and that the at least one second conveying means (7) comprises a tray (20.1, 20.2) for conveying a second item (2.2) to be conveyed lying on the tray (20.1, 20.2).

11. The conveying system (1) according to claim 9, wherein the at least one first conveying means (6) comprises a tray (20.1, 20.2) for conveying a first item (2.1) to be conveyed lying on the tray (20.1, 20.2) and the at least one second conveying means (7) comprises a tray (20.3) for conveying a second item (2.2) to be conveyed lying on the tray (20.3).

12. The conveying system (1) according to claim 8, wherein the at least one tray (20.1, 20.2, 20.3) comprises a tray plate (21) with a tray conveying surface (22), wherein the tray plate (21) is connected to a tilting device (24) which can tilt the tray plate (21) in a first rotational direction about a tilting axis (A) arranged parallel to the conveying direction of the conveying path (30) from a transport position into a first unloading position, in order to unload an item (2.1, 2.2) to be conveyed lying on the tray conveying surface (22) in a first direction transversely to the conveying direction (30).

13. The conveying system (1) according to claim 12, wherein the tray plate (21) can be tilted about the tilting axis from the transport position into a second unloading position, in order to unload an item (2.1, 22) to be conveyed lying on the tray conveying surface (22) in a second lateral direction transversely to the conveying direction (30).

14. The conveying system (1) according to claim 12, wherein the tilting device (24) comprises a control element (25.1, 25.2), by which the tray plate (21) is tilted into the first or second unloading position in an interaction with a control slide-way (66.1, 66.2).

15. The conveying system (1) according to claim 12, wherein the tray conveying surface (22) is surrounded at least partially by a retention frame (23).

16. The conveying system (1) according to claim 8, wherein at least two trays (20.1, 20.2, 20.3) arranged directly one behind the other on the conveying path (30) form a composition of trays (27.1, 27.2).

17. The conveying system (1) according to claim 16, wherein at least two trays (20.1, 20.2, 20.3) are constituted differently.

18. The conveying system (1) according to claim 16, wherein the conveying system (1) comprises a plurality of compositions of trays (27.1, 27.2), which are arranged along the conveying path (30) in each case at a distance from one another.

19. The conveying system (1) according to claim 1, wherein the conveying system (1) comprises at least one first loading device (51) for loading the at least one first conveying means (6) with a first item (2.1) to be conveyed and/or that the conveying system (1) comprises at least one second loading device (55) for loading the at least one second conveying means (7) with a second item (2.2) to be conveyed.

20. The conveying system (1) according to claim 19, wherein the first loading device (51) and/or the second loading device (55) is configured for loading an assembled conveying support (10.1, 10.2) with a first item (2.1) to be conveyed and/or is configured for loading a tray (20.1, 20.2) in a conveying position with a second item (2.2) to be conveyed.

21. The conveying system (1) according to claim 1, wherein the conveying system (1) comprises at least one first unloading device (61.1, 61.2) for unloading a first item (2.1) to be conveyed from at least one first conveying means (6) and/or that the conveying system (1) comprises at least one second unloading device (65.1, 65.2) for unloading a second item (2.2) to be conveyed from at least one second conveying means (7).

22. The conveying system (1) according to claim 21, wherein the conveying system (1) comprises at least one first unloading device (61.1, 61.2) for unloading a first item (2.1) to be conveyed from an assembled conveying support (10.1, 10.2) and/or that the conveying system (1) comprises at least one second unloading device (65.1, 65.2) for unloading a second item (2.2) to be conveyed from a tray (20.1, 20.2, 20.3).

23. A method for operating a conveying system (1) according to claim 1, comprising the steps:
a. providing the conveying system;
b. loading of the at least one first conveying means (6) with a first item (2.1) to be conveyed; and/or
c. loading of the at least one second conveying means (7) with a second item (2.1) to be conveyed;
d. conveying of the at least one first conveying means (6) along the conveying path (30) to a first unloading device (61.1, 61.2) and unloading of the first item (2.1) to be conveyed; and/or
e. conveying of the at least one second conveying means (7) along the conveying path (30) to a second unloading device (62.1, 62.2) and unloading of the second item (2.2) to be conveyed in an unloading station.

24. The method according to claim 23, wherein the at least one first conveying means (6) and/or the at least one second conveying means (7) comprises a tray (21.1, 21.2, 21.3), which is brought into a loading position before the loading step and/or is held in a loading position during the loading.
